(19) United States
(12) Patent Application Publication
(10) Pub. No.: US 2002/0136613 A1
(43) Pub. Date: Sep. 26, 2002

(54) Rotary actuator for precision applications

(75) Inventor: Terry Lynn Tidwell, Fayetteville, AR (US)

Correspondence Address: WRIGHT LINDSEY & JENNINGS, LLP, 200 WEST CAPITOL AVENUE, SUITE 2200, LITTLE ROCK, AR, 722013699

(73) Assignee: Artran, Inc.

(21) Appl. No.: 09/814,137

(22) Filed: Mar. 21, 2001

(51) Int. Cl. B23C 1/12

(52) U.S. Cl. 409/201; 409/211

(57) ABSTRACT

A rotary actuator with improved damping and stiffness is disclosed. The rotary actuator includes one or more bearing plates that form sliding-surface bearings to provide the desired preload to the rotary actuator. One embodiment of the invention includes a multi-piece bearing plate that makes repair or replacement of the bearing material in the sliding-surface bearings easy to perform. Another embodiment for applications where heat dissipation is critical includes thermal barriers on either side of the sliding-element bearings, with resilient members between the thermal barrier and a bearing ring used to supply the appropriate preload to the output shaft. The invention is particularly suited to precision applications, such as the drive unit for the swivel mechanism on the spindle head of certain types of five-axis milling machines.

### BACKGROUND OF THE INVENTION

The present invention relates to rotary actuators, and in particular to rotary actuators designed for precision applications such as machine tools.

A rotary actuator may be defined as a mechanism for translating or controlling rotary motion. One important class of rotary actuators is speed reducers (sometimes also referred to as gear reducers). The function of a speed reducer is to receive rotational energy in the form of a particular torque and rotational speed at its input, and translate that rotational energy into a higher torque and lower rotational speed at its output. This is generally accomplished by means of a gearing mechanism within the speed reducer.

Speed reducers are a common element in the drive system for high-torque, low-speed applications. In general, electric motors that provide a relatively low-torque, high-speed output are significantly less expensive than high-torque, low-speed motors. Many applications, however, require a motor with a high-torque output with a low rotational speed. Thus speed reducers are often coupled with a low-torque electric motor in the drive system for such applications as a less expensive alternative to a high-torque, low-speed motor.

A typical speed reducer comprises an input shaft, an output shaft, some arrangement of gears whereby rotational energy is transferred from the input shaft to the output shaft, one or more bearings, and a drive housing. Most speed reducers use mechanical gearing mechanisms, but other arrangements are possible. Speed reducers may be found in many sizes and configurations, including elbow, offset, and straight-line varieties. Virtually all speed reducers, however, use low-friction internal bearings. These bearings are most often of the rolling-element variety, such as ball bearings or roller-type bearings. Other possible types of low-friction bearings might include hydrostatic bearings. Speed reducers that incorporate the output bearings within their housing are commonly known as bearing reducers.

Rolling-element and hydrostatic bearings provide relatively low friction, and thus these bearings are ideal for applications where the minimization of energy loss is critical. Most low-friction bearing reducers do not, however, provide sufficient damping and stiffness for precision applications where the driven component is subject to large dynamic forces. Damping may be generally defined as the ability of a component to dissipate rather than transmit energy. Stiffness may be defined as the ability of a component to maintain its position under load. Low-friction bearings have poor damping and stiffness characteristics simply as a function of their design. The ball elements of ball bearings only contact the bearing surface at a point on the sphere of each element, and thus there is only a tiny contact area between the ball elements and the bearing surface. This small contact area results in poor damping qualities. The rollers of roller bearings have a greater surface contact area with the bearing surface, since each of the rollers in such bearings contact the bearing surface along a line down the side of each of the cylindrical or frustoconical roller elements. As a result, roller bearings have better damping than ball bearings. Sliding-element bearings have damping qualities that are superior to rolling-element bearings because the sliding element contacts the bearing surface along a plane. The size of this contact plane, which is determined by the area of the bearing surface and the sliding element, may be varied to control the amount of damping provided by the sliding-element bearing.

As noted above, damping is particularly important for precision applications where the driven component is subject to large dynamic forces. Precision applications are those in which the accuracy and controllability of the speed reducer output characteristics must meet strict tolerances. One precision application where high accuracy and controllability is required, as well as superior stiffness and damping qualities, is milling machines. In particular, the drive system for the spindle head of a five-axis milling machine requires very high accuracy of motion and very high stability under dynamic loads. Unlike traditional three-axis machines, some five-axis machines include the capability for the spindle head to swivel. The swivel of the spindle head must be controlled with great accuracy in order to maintain the tolerance of parts produced using the milling machine. Any error in the positioning of the spindle head along its swivel path will be magnified at the tip of the machining tool as the spindle head moves through an arc. The degree to which this error is magnified is a function of the length of the attached tool.

Due to inaccuracies in the manufacturing of the gear assemblies and clearances necessary for smooth, efficient operation, most rotary actuators have some rotational deflection in the gear assembly when a load is applied to the output shaft. This rotational deflection, or lack of torsional stiffness, is sometimes called soft wind-up, hysteresis, backlash, or lost motion. Typical sources of this problem in bearing reducers include the misalignment of components; manufacturing errors or poor tolerances; and friction between moving parts. Generally, there is a relatively large difference between the coefficients of static and dynamic friction for these devices.

While there are a few high-precision bearing reducers available on the market today, they are generally designed in the same manner as general-use speed reducers, except that very tight tolerances are enforced on the manufacture and fitting of their critical components. The requirement of very tight tolerances significantly increases the cost of these devices, and thereby offsets the cost advantage of using a speed reducer with a low-torque electric motor for precision applications.

Certain precision applications subject to large dynamic forces, such as the drive system for the swivel motion of a spindle head on a milling machine, require that a “preload” be applied to the drive system. A preload mechanism can be thought of as an energy absorption device that isolates the rest of the machine from large, temporary force spikes; this effect is commonly referred to as damping. Because these forces are only nominally predictable and are subject to rapid changes, failure to preload the drive system could cause the dynamic forces to exceed the performance specifications of the machine, and thereby damage the machine, damage the workpiece, or endanger the machine operator. Furthermore, the deflection and static load characteristics for many types of speed reducers are not linear, especially at or near the no-load condition. When such devices first come under load, they deflect more per unit load than they do after some minimum force is achieved. Preloading is also useful in “taking up” this softness around the no-load condition.

Prior art bearing reducers as described above do not include a means for preloading, and therefore cannot be used without additional drive system elements in applications where dynamic force spikes are a concern. In fact, preloading would be detrimental to bearing reducers for many common applications, since preloading would increase the friction inherent in the device, and therefore would increase the energy losses in the drive system as well as increase the heat generated during use. For precision applications such as the swivel drive system for a spindle head on a milling machine, energy losses and heat generation are a less important concern than sufficient stiffness and damping. Heat generation in such applications will be limited by the relatively slow rotational speed of the spindle head, and the energy loss is less important than precisely controlling the position of the spindle head during milling.

The prior art does include a number of mechanical means for achieving preloading of rotary actuators. For example, torsion springs or air or hydraulic cylinders could be used to resist unwanted deflections and to absorb energy. Such devices as these, however, do not add significant bearing load capacity to the drive and tend to be bulky or unwieldy in many applications. Also, it is more difficult to arrange this type of preload into a “normally on” configuration, which is important in many applications for safety reasons, such as the stated application of a swivel drive mechanism for the spindle head of a milling machine.

### SUMMARY OF THE INVENTION

The present invention comprises an inexpensive bearing reducer produced with relatively low tolerances that is nevertheless suited for high-precision applications. The invention enhances the stiffness and damping characteristics of the gear assembly and bearings of a rotary actuator by adding one or more sliding element bearings in a plane parallel to the plane of rotation of the rotary actuator. The sliding element bearing is sized to provide a torsionally-acting friction force equal to the desired torsional preload. This invention may also be utilized to supply any desired axial preload. Further, by using at least two auxiliary bearings, any desired torsional preload and any desired axial preload may be achieved simultaneously. Also, by using at least two auxiliary bearings, it is possible to achieve both of these objectives without altering the preload of the bearings within the speed reducer housing, which otherwise might alter their useful service life.

Because the invention includes the use of auxiliary bearings that are relatively stiff compared to the internal bearings of the device, the auxiliary bearings are more prone to wear. In some embodiments, the invention comprises means to easily access and service, or simply replace, the stiffer bearing element or elements. Also, in applications where thermal control is critical, the invention may include insulating barriers between the auxiliary bearings and the other reducer elements, with springs or other resilient means used to provide the appropriate preload force.

It is therefore an object of the present invention to provide for a speed reducer with improved axial and torsional stiffness.

It is a further object of the present invention to provide for a speed reducer wherein axial and torsional stiffness may be increased to any desired level based on the amount of preload built into a set of auxiliary bearings.

It is also an object of the present invention to provide for a speed reducer wherein axial and torsional stiffness may be improved without altering the preload on the rolling-element bearings by using auxiliary bearings.

It is also an object of the present invention to provide for a speed reducer with auxiliary bearings in which the damping of the system is increased through the friction forces and viscous shear forces acting over the large surface area of the auxiliary bearings.

It is also an object of the present invention to provide for a speed reducer in which the trueness of circularity of the output shaft rotation is dominated by the stiffer auxiliary bearings and thus becomes generally a function of the quality of those bearings rather than the quality of the interior bearings.

It is also an object of the present invention to provide for a speed reducer useful for precision applications that may be manufactured easily and at a low cost.

It is also an object of the present invention to provide for a speed reducer with enhanced service life by the use of easily serviced auxiliary bearings.

It is also an object of the present invention to provide for a speed reducer whereby heat transfer to other parts of the machine is inhibited and the preload on the bearings is maintained constant using preload springs and thermal barriers.

It is also an object of the present invention to negate the need for counterbalance systems or brake motors in some applications where gravity would otherwise cause the actuator to spontaneously move when power was shut off.

These and other features, objects and advantages of the present invention will become better understood from a consideration of the following detailed description of the preferred embodiments and appended claims in conjunction with the drawings as described following.

### BRIEF DESCRIPTION OF THE SEVERAL VIEWS OF THE DRAWINGS

FIG. 1. is a cut-away elevational view of a preferred embodiment of the present invention in which the bearing plates are mounted to the input and output shafts.

FIG. 2 is a cut-away elevational view of a preferred embodiment of the present invention in which the bearing plates are mounted to the housing.

FIG. 3 is a cut-away elevational detail view of a preferred embodiment of the present invention with a multi-piece bearing plate.

FIG. 4 is a plan view of a multi-piece bearing plate according to a preferred embodiment of the present invention.

FIG. 5. is a cut-away elevational detail view of a preferred embodiment of the present invention that may be used in situations where thermal control is critical.

### DETAILED DESCRIPTION OF THE PREFERRED EMBODIMENTS

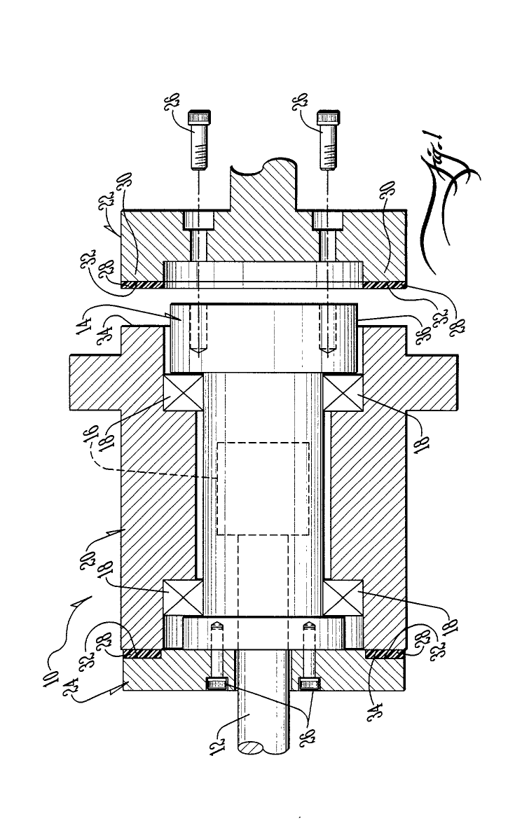

With reference to FIG. 1, a first preferred embodiment of the present invention may be described. Bearing reducer 10 comprises input shaft 12, output shaft 14, and gearing mechanism 16 that links input shaft 12 to output shaft 14. Gearing mechanism 16 functions to lower the speed and increase the torque applied to output shaft 14 relative to input shaft 12. Many types of gearing mechanism 16 are known in the art and may be used with the invention. Input shaft 12 and output shaft 14 ride on rolling-element bearings 18 within housing 20. Numerous types of suitable rolling-element bearings 18 are known in the art. Rolling-element bearings 18 are characterized by a relatively low internal friction, such that very little energy is lost in the transfer of rotational energy to input shaft 12, through gearing mechanism 16, and then into output shaft 14. Rolling-element bearings 18 do not, however, provide a sufficient degree of stiffness at output shaft 14 for some applications.

In the first preferred embodiment of FIG. 1, output bearing plate 22 is mounted to the housing of bearing reducer 10 at output shaft 14 with bolts 26. Likewise, input bearing plate 24 is mounted to output shaft 14 with bolts 26. Each of output bearing plate 22 and input bearing plate 24 are firmly fitted against output shaft 14 with an annular surface 32 on the inside surface of each of output bearing plate 22 and input bearing plate 24 extending beyond the circumference of output shaft 14. In the case where output shaft shoulder 36 extends beyond the end of housing 20, as shown in FIG. 1, output bearing plate 22 may include a lip 30 that extends inward such that the plate forms a cup around output shaft shoulder 36, with annular surface 32 on output bearing plate 22 appearing on the face of lip 30.

Bearing material 28 is adhered to annular surface 32 on each of output bearing plate 22 and input bearing plate 24, such that bearing material 28 presses against bearing surface 34 at each end of housing 20. Preferably, one of several suitable commercially available materials made of polymer or polymer-based composites are used for bearing material 28. In particular, the preferred polymer for bearing material 28 is polytetrafluoroethylene (PTFE). PTFE is unique in that its coefficients of static and dynamic friction are nearly equal. Some commons trade names for such materials are Garlock, which is manufactured by Garlock Sealing Technologies of Palmyra, New York, and Turcite, which is manufactured by Busack+Shambam, Inc. of Abindgon, United Kingdom. These materials are cut to the desired shape and adhered to output bearing plate 22 and input bearing plate 24 to form bearing material 28. The adhesive used to attaching bearing material 28 to annular surface 32 is preferably Scotch-Weld, which is manufactured by the 3M Corporation of St. Paul, Minn., but other suitable adhesives may also be used. Bearing surface 34 is ground or milled to a bearing-quality finish.

In alternative embodiments, injectable bearing materials may be used in place of sheet polymer-based materials for bearing material 28. Preferably, injectable materials sold under the trade names Moglice and Diamante, both manufactured by Diamante Metallplastic Gmbh of Mönchengladbach, Germany, can be used, but other similar materials are available that may be substituted. Only one of the bearing surface 34 and annular surface 32 must be machined to bearing quality when injectable materials are used for bearing material 28.

Bearing material 28 may be ground such that the desired preload is achieved at output shaft 14 when output bearing plate 22 and input bearing plate 24 are firmly seated with respect to output shaft 14. The preload is generated from the frictional forces between bearing material 28 and bearing surface 34. The pressure with which bearing material 28 is pressed against bearing surface 34 will then determine the preload. Tightening or loosening of bolts 26 will increase or decrease, respectively, the preload. Other fastening devices or mechanisms may alternatively be used to apply pressure between bearing material 28 and bearing surface 34 such that the desired preload is achieved.

The preload can also be varied by controlling the size of annular surface 32 to which bearing material 28 is applied and the size of bearing surface 34. The torsional preload force at bearing material 28 is proportional to the normal force (that is, the axial preload) of output shaft 14 and the effective radius at which the normal force is applied. Thus, for a given desired axial preload, the radius of annular surface 32 must be sized to deliver the desired torsional preload, while taking into account the coefficient of friction of bearing material 28. The normal force is determined by the amount of “interference” between bearing material 28 and bearing surface 34. Interference is measured as the combined amount that bearing material 28 compresses and output bearing plate 22 deflects when bolts 26 are tightened that connect output bearing plate 22 to output shaft 14. The manufacturers of materials that may be used for bearing material 28 commonly furnish specifications as to the compressibility of such material, including the force required to compress a given area of such material by a given distance.

The function of bearing reducer 10 as shown in FIG. 1 may be described as follows. As rotational energy is applied at input shaft 12, the friction between bearing material 28 and bearing surface 34 at each of output bearing plate 22 and input bearing plate 24 serves to increase the stiffness of bearing reducer 10 at output shaft 14. Since the sliding-element bearings formed by the interference between bearing material 28 and annular surface 32 are much stiffer than rolling-element bearings 18, the sliding-element bearings force the trueness of circularity of output shaft 14 rotation to be a function of the flatness of annular surface 32 and bearing surface 28 with respect to each other. Thus deviations in output shaft 14 rotation arising from manufacturing errors and misalignment of components are minimized. Also, since the sliding-element bearings formed in the preferred embodiment contain one continuous flat surface, high surface quality (that is, flatness to a high degree of accuracy) is easily and cost-effectively achieved with commercially available milling and grinding equipment.

In other alternative embodiments, only one sliding element bearing may be used, such that only one of output bearing plate 22 and input bearing plate 24 is present. The use of two sliding-element bearings, however, has the additional advantage of providing preload at output shaft 14 without increasing the preload on rolling-element bearings 18. By precisely balancing the friction between bearing material 28 and bearing surface 34 at each end of output shaft 14, the desired preload at output shaft 14 can be achieved without applying any additional preload upon rolling-element bearings 18. Since an additional preload on rolling-element bearings 18 may reduce their service life, the use of sliding-element bearings at each end of output shaft 14 may increase the service life of bearing reducer 10. This becomes especially important since rolling-element bearings 18 are located deep within housing 20, and therefore service to or replacement of rolling-element bearings 18 would be relatively time-consuming and expensive. It should also be noted that alternative embodiments of the present invention may comprise more than two sliding-element bearings.

In further alternative embodiments, annular surface 32 can be so sized and placed such that bearing material 28 slides against any surface on housing 20. Annular surface 32 could be located on a lip extending from housing 20, or a separate part attached to, and thereby incorporated into, housing 20. In addition, the placement of bearing material 28 and bearing surface 34 may be reversed, such that bearing material 28 is adhered to housing 20 or other components instead of annular surface 32 on output bearing plate 22 or input bearing plate 24, and bearing surface 34 appears on output bearing plate 22 or input bearing plate 24.

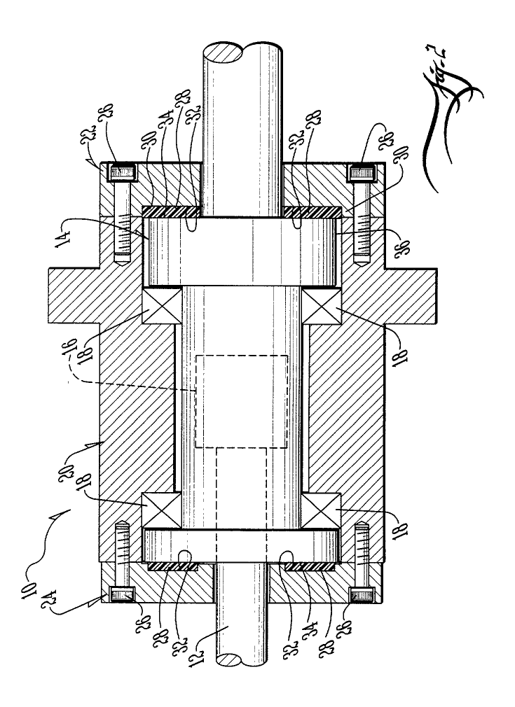

With reference now to FIG. 2, a second preferred embodiment of the present invention may be described. This second preferred embodiment is generally similar to the embodiment of FIG. 1, except that in this embodiment output bearing plate 22 and input bearing plate 24 are attached to opposite ends of housing 20 with bolts 26. Input shaft 12 and output shaft 14 extend through input bearing plate 24 and output bearing plate 22, respectively, with output bearing plate 22 making no contact with output shaft 14 where it passes through output bearing plate 22. Bearing material 28 is mounted on the interior surface of output bearing plate 22 and input bearing plate 24, such that it contacts output shaft shoulder 36 at the output end of bearing reducer 10, and it contacts the end of output shaft 14 at the input end of bearing reducer 10. Annular surface 32 in this embodiment is located radially inward from its location in the embodiment of FIG. 1, such that bolts 26 may pass through output bearing plate 22 and input bearing plate 24 into drive housing 10. Bearing surface 34 appears opposite annular surface 32 and bearing material 28 on the input end of output shaft 14 and the outside surface of lip 30 of output shaft 14. Thus in this embodiment, output bearing plate 22 and input bearing plate 24 do not turn with output shaft 14, but are instead stationary with respect to housing 10.

As with the other embodiments described herein, bearing material 28 is ground such that the desired preload is achieved at output shaft 14 when output bearing plate 22 and input bearing plate 24 are firmed seated. In the case of the embodiment of FIG. 2, output bearing plate 22 and input bearing plate 24 are seated against the ends of housing 20. As rotational energy is applied at input shaft 12, the friction between bearing material 28 and bearing surface 34 on output shaft 14 at each of output bearing plate 22 and input bearing plate 24 serves to increase the stiffness of bearing reducer 10 at output shaft 14. Also as with other embodiments, since the sliding-element bearings formed in the preferred embodiment by bearing material 28 and bearing surface 34 contain one continuous flat surface at bearing surface 34, high surface quality (that is, flatness to a high degree of accuracy) is easily and cost-effectively achieved with commercially available milling and grinding equipment.

In other alternative embodiments based on the embodiment of FIG. 2, only one sliding element bearing may be used, such that only one of output bearing plate 22 and input bearing plate 24 is present. The use of two sliding-element bearings, however, has the additional advantage as described with respect to the embodiment of FIG. 1 of providing preload at output shaft 14 without increasing the preload on rolling-element bearings 18. In another alternative embodiment, the invention also comprises a combination of the designs of FIG. 1 and FIG. 2, such that one of output bearing plate 22 and input bearing plate 24 is attached to output shaft 14 with bolts 26, while the other is attached to housing 10 or to a machine to which housing 10 is mounted.

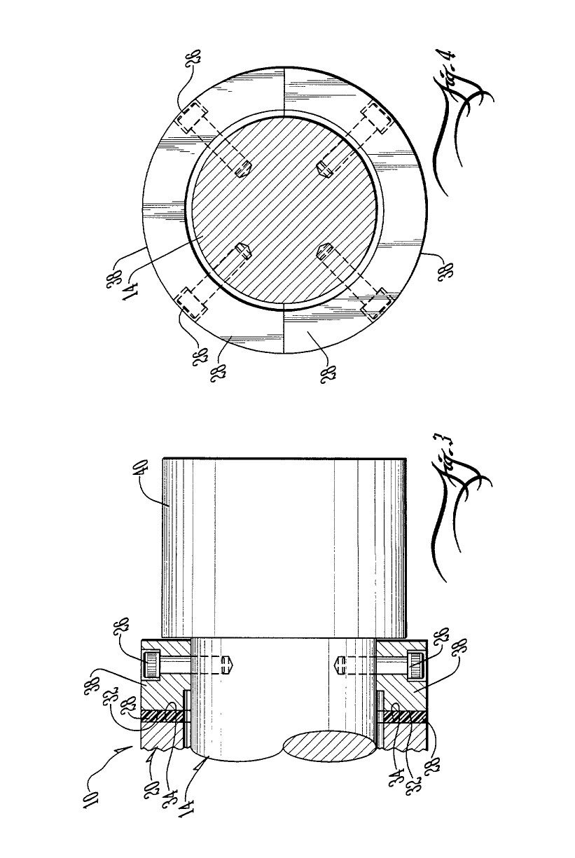

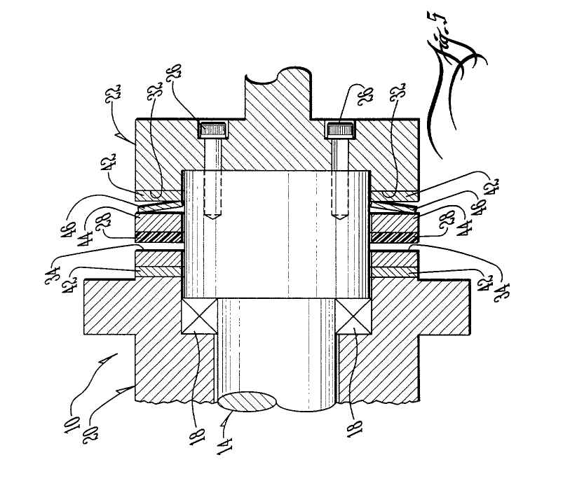

Referring now to FIGS. 3 and 4, a modification of the embodiment of the invention shown in FIG. 1 is disclosed in which bearing material 28 may be easily and quickly replaced, thereby making bearing material 28 a wear element and increasing the service life of bearing reducer 10. The loads being driven by typical bearing reducers during use are large and bulky, and require considerable time and effort to disconnect from the bearing reducer for the replacement of a bearing. In addition, the time required to reconnect the load to the bearing reducer, including the time to reset the alignment of the overall drive system, makes such an operation costly to an operator whose machine must be down while this replacement operation occurs.

In the present invention, since the bulk of the bearing loads are carried by the sliding-element bearings formed by bearing material 28 and bearing surface 34, these bearings will wear more quickly than rolling-element bearings 18. To make bearing material 28 easily replaceable without disconnecting bearing reducer 10 from the drive system of which it is a part, the bearing plate or plates can be formed by bearing plate halves 38 as shown in FIG. 4. Each bearing plate half 38 is connected to output shaft 14 using bolts 26. Each bearing plate half 38 can be easily removed by simply removing the appropriate bolts 26, without disconnecting output shaft 14 from load 40, as illustrated in FIG. 3. Bearing material 28, which is adhered to annular surface 32 on each bearing plate half 38, can then be easily replaced, and bearing plate half 38 can be reattached to output shaft 14 with bolts 26.

Numerous alternative embodiments of the invention may be constructed using bearing plates that are easily removable. The invention is not limited to removable bearing plates comprising two bearing plate halves 38, but also comprises bearing plates of any number of pieces. In addition, the easily removable bearing plate can be attached at either the input or output end of bearing reducer 10, and can be one, some, or all of the bearing plates used in bearing reducer 10.

A further embodiment of the invention, which is a modification of the embodiment shown in FIG. 1, may now be described with reference to FIG. 5. In some applications, particularly where there is a higher degree of relative motion between bearing material 28 and bearing surface 34, a considerable amount of heat may be generated through friction at the interface between bearing material 28 and bearing surface 34. This heat may lead to damage or reduced life for those components of bearing reducer 10 directly exposed to the heat, or machine components directly adjacent to the interface of bearing material 28 and bearing surface 34. Due to the use of a bearing plate, however, thermal barriers 42 may be installed to reduce this problem. As shown in FIG. 5, bearing surface 34 is formed of a ring that is insulated from housing 20 by annular-shaped thermal barrier 42. Thermal barriers 42 may be formed of any suitable materials with appropriate heat-insulating qualities as are known in the art. Bearing surface 34 in this embodiment may be formed of any suitably hard material, such as steel, that may be machined to a bearing-quality surface. Opposite bearing surface 34 is bearing material ring 44, which may also be formed of steel or the like. Bearing material 28 is adhered to the inside surface of bearing material ring 44. Adjacent to the outside surface of bearing material ring 44 is spring washer 46. The outside edge of spring washer 46 rests against thermal barrier 42, which is attached to annular surface 32.

When output bearing plate 22 is attached to output shaft 14 and firmly seated with bolts 26, spring washer 46 provides a force that presses bearing material 28 against bearing surface 34, thereby providing the preload that increases the stiffness of bearing 10. In addition to the means of controlling the amount of the preload as described above with respect to the embodiment of FIG. 1, the preload may also be varied by adjusting the tension of spring washer 46. Elements of bearing reducer 10 and surrounding machine components are protected from heat generated due to the friction between bearing material 28 and bearing surface 34 by thermal barriers 42.

The present invention has been described with reference to certain preferred and alternative embodiments that are intended to be exemplary only and not limiting to the full scope of the present invention as set forth in the appended claims.

What is claimed is:

1. A rotary actuator, comprising:
(a) a housing comprising a first end and a second end;
(b) an output shaft at least partially within said housing;
(c) a low-friction bearing between said housing and said output shaft, whereby said output shaft may rotate freely upon its axis within said housing;
(d) a first bearing plate adjacent to said first end of said housing;
(e) a first bearing material attached to one of said housing and said first bearing plate and located between said housing and said first bearing plate; and
(f) a first bearing surface formed on one of said housing and said first bearing plate opposite said first bearing material, whereby a sliding element bearing is formed between said housing and said first bearing plate when one of said first bearing material and first bearing surface is rotated with respect to the other, and wherein the friction between said first bearing material and said first bearing surface when said output shaft is rotating is greater than the friction within said low-friction bearing.

2. The rotary actuator of claim 1, wherein said first bearing plate is rigidly attached to said output shaft, and said first bearing material is adhered to said first bearing plate.

3. The rotary actuator of claim 2, wherein said first bearing plate is removably attached to said output shaft, and said first bearing plate comprises a plurality of first bearing plate pieces, wherein each of said first bearing plate pieces is individually removable from said output shaft.

4. The rotary actuator of claim 2, wherein said housing comprises said bearing surface.

5. The rotary actuator of claim 1, wherein said first bearing plate is rigidly attached to said output shaft, and said first bearing material is adhered to said housing.

6. The rotary actuator of claim 5, wherein said first bearing plate comprises said first bearing surface.

7. The rotary actuator of claim 1, further comprising:
(a) a second bearing plate adjacent to said second end of said housing;
(b) a second bearing material attached to one of said housing and said second bearing plate and located between said housing and said second bearing plate; and
(c) a second bearing surface on one of said housing and said second bearing plate opposite said second bearing material, whereby a sliding element bearing is formed between said housing and said second bearing plate.

8. The rotary actuator of claim 7, wherein the friction within said second bearing material and said second bearing surface when said output shaft is rotating is greater than the friction within said low-friction bearing.

9. The rotary actuator of claim 8, wherein said second bearing plate is rigidly attached to said output shaft, and said bearing material is adhered to said first bearing plate.

10. The rotary actuator of claim 9, wherein said second bearing plate is removably attached to said output shaft, and said second bearing plate comprises a plurality of second bearing plate pieces, wherein each of said second bearing plate pieces is individually removable from said output shaft.

11. The rotary actuator of claim 9, wherein said housing comprises said bearing surface.

12. The rotary actuator of claim 8, wherein said second bearing plate is rigidly attached to said output shaft, and said second bearing material is adhered to said housing.

13. The rotary actuator of claim 12, wherein said second bearing plate comprises said second bearing surface.

14. The rotary actuator of claim 1, wherein said first bearing plate is rigidly attached to said housing, and said first bearing material is adhered to said first bearing plate.

15. The rotary actuator of claim 14, wherein said first bearing plate is removably attached to said housing, and said first bearing plate comprises a plurality of first bearing plate pieces, wherein each of said first bearing plate pieces is individually removable from said housing.

16. The rotary actuator of claim 14, wherein said output shaft comprises said bearing surface.

17. The rotary actuator of claim 1, wherein said first bearing plate is rigidly attached to said housing, and said first bearing material is adhered to said output shaft.

18. The rotary actuator of claim 17, wherein said first bearing plate comprises said first bearing surface.

19. The rotary actuator of claim 8, wherein said second bearing plate is rigidly attached to said housing, and said bearing material is adhered to said first bearing plate.

20. The rotary actuator of claim 19, wherein said second bearing plate is removably attached to said housing, and said second bearing plate comprises a plurality of second bearing plate pieces, wherein each of said second bearing plate pieces is individually removable from said housing.

21. The rotary actuator of claim 19, wherein said output shaft comprises said bearing surface.

22. The rotary actuator of claim 8, wherein said second bearing plate is rigidly attached to said housing, and said second bearing material is adhered to said output shaft.

23. The rotary actuator of claim 22, wherein said second bearing plate comprises said second bearing surface.

24. The rotary actuator of claim 1, further comprising a first preload adjustment means connecting said first bearing plate and one of said output shaft and said housing whereby the pressure between said first bearing material and said first bearing surface may be adjusted.

25. The rotary actuator of claim 24, wherein said first preload adjustment means comprises a plurality of bolts.

26. The rotary actuator of claim 7, further comprising:
(a) a first preload adjustment means connecting said first bearing plate and one of said output shaft and said housing whereby the pressure between said first bearing material and said first bearing surface may be adjusted; and
(b) a second preload adjustment means connecting said second bearing plate and one of said output shaft and said housing whereby the pressure between said second bearing material and said second bearing surface may be adjusted.

27. The rotary actuator of claim 26, wherein at least one of said first preload adjustment means and said second preload adjustment means comprises a plurality of bolts.

28. The rotary actuator of claim 26, wherein said first preload adjustment means and said second preload adjustment means may be adjusted independently.

29. The rotary actuator of claim 1, further comprising means for adjusting the torsional preload of the rotary actuator.

29. The rotary actuator of claim 7, further comprising means for independently adjusting the torsional preload and axial preload of the rotary actuator.

31. The rotary actuator of claim 7, further comprising means for adjusting the torsional preload of the rotary actuator without changing the axial preload on said low-friction bearing.

32. A rotary actuator, comprising:
(a) a housing comprising a first end and a second end;
(b) an output shaft within said housing;
(c) a low-friction bearing between said housing and said output shaft, whereby said output shaft may rotate freely upon its axis within said housing;
(d) a first bearing plate adjacent to said first end of said housing;
(e) a first bearing ring between said housing and said first bearing plate;
(f) a first bearing material adhered to said first bearing ring;
(g) a resilient member between said first bearing ring and said first bearing plate, wherein said first bearing ring is biased away from said first bearing plate by said resilient member;
(h) a first bearing surface between said housing and said first bearing material, whereby a sliding element bearing is formed between said housing and said first bearing ring when one of said housing and said first bearing ring is rotated with respect to the other, and wherein the friction between said first bearing material and said first bearing surface when said output shaft is rotating is greater than the friction within said low-friction bearing; and
(i) a first housing thermal barrier between said housing and said first bearing surface.

33. The rotary actuator of claim 32, wherein said first bearing plate is rigidly attached to said output shaft.

34. The rotary actuator of claim 33, wherein said first bearing plate is removably attached to said output shaft, and said first bearing plate comprises a plurality of first bearing plate pieces, wherein each of said first bearing plate pieces is individually removable from said output shaft.

35. A rotary actuator, comprising:
(a) a housing comprising a first end and a second end;
(b) a first bearing plate adjacent to said first end of said housing;
(c) a first bearing material attached to one of said housing and said first bearing plate and located between said housing and said first bearing plate, wherein said first bearing material comprises a polymer; and
(d) a first bearing surface formed on one of said housing and said first bearing plate opposite said first bearing material, whereby a sliding element bearing is formed between said housing and said first bearing plate when one of said first bearing material and first bearing surface is rotated with respect to the other.

36. The rotary actuator of claim 35, wherein said first bearing material comprises a polymer wherein the coefficients of static and kinetic friction for such polymer are about equal.

37. The rotary actuator of claim 35, wherein said first bearing material comprises polytetrafluoroethylene.

38. A milling machine, comprising:
(a) a motor;
(b) a speed reducer in communication with such motor, wherein said speed reducer converts a high-speed, low-torque input from said motor into a low-speed, high-torque output, and said speed reducer comprising:
(i) a housing comprising a first end and a second end;
(ii) a first bearing plate adjacent to said first end of said housing;
(iii) a first bearing material attached to one of said housing and said first bearing plate and located between said housing and said first bearing plate; and
(iv) a first bearing surface formed on one of said housing and said first bearing plate opposite said first bearing material, whereby a sliding element bearing is formed between said housing and said first bearing plate when one of said first bearing material and first bearing surface is rotated with respect to the other; and
(c) a spindle head in communication with said speed reducer whereby said speed reducer drives at least one degree of motion of said spindle head.

39. The milling machine of claim 34, wherein said milling machine is a five-axis milling machine, and said spindle head drives said speed reducer in a swivel motion.
